(19) United States
(12) Patent Application Publication
(10) Pub. No.: US 2005/0080897 A1
(43) Pub. Date: Apr. 14, 2005

(54) Remote management utility

(75) Inventors: Richard Braun, Mechanicsville, VA (US); Steven D. Radabaugh, Richmond, VA (US); Randal L. Womack, Bumpass, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 10/675,159

(22) Filed: Sep. 29, 2003

(51) Int. Cl. G06F 15/173

(52) U.S. Cl. 709/225

(57) ABSTRACT

A method for using a utility at an end user device is provided. The method includes assigning an elevated access right to a remote user identifier and a limited access right to an end user identifier, where the limited access right prevents access to the utility at the end user device. The utility is accessed at the end user device using the remote user identifier, where the utility allows the remote user identifier to select an administrative tool at the end user device. The administrative tool is launched according to the elevated access right while the limited access right of the end user identifier is maintained. At least one administrative task is performed at the end user device using the administrative tool.

### TECHNICAL FIELD OF THE INVENTION

This invention relates generally to the field of computer networks and more specifically to a remote management utility.

### BACKGROUND OF THE INVENTION

Managing end users in a computer network may involve restricting access to certain functions at the end user computer. For example, an end user may be prevented from installing new applications, changing printer assignment, adding hardware, and other similar functions. A technique for restricting access involves setting up an end user profile at a server where the end user is given limited access rights. With limited access rights, the end user may only be able to access a specific domain at the server and local applications without being able to modify any settings of the end user computer. This known technique, however, may be challenging to implement in networks that use certain operating systems such as Windows or Windows 2000 because, in those circumstances, a remote user, such as a help desk technician or a network administrator, may only gain access rights to the end user computer equal to the limited access rights of the end user. Accordingly, the remote user may not be able to effectively perform maintenance of or troubleshoot the end user computer using the limited access rights of the end user.

Another technique for facilitating remote management of a network involves assigning all end users of a network access rights of a local administrator. This technique, however, may cause security concerns because end users may be able to access any domain of the network and perform administrative tasks at the end user computer without verification or assistance from a help desk technician and/or network administrator. Consequently, known techniques for managing and restricting end user access may be unsatisfactory in certain situations.

### SUMMARY OF THE INVENTION

In accordance with the present invention, systems and methods for elevating the access right of a remote user and using a remote management utility are provided. A remote user may be assigned elevated access rights that may be used to access the remote management utility at the end user computer while maintaining limited access rights assigned to the end user. The utility launches administrative tools that may enable the remote user to perform administrative tasks at the end user computer. Additionally, the end user may be logged into the network at the end user computer, but may not be able to perform the administrative tasks at the end user computer according to the limited access rights assigned to the end user. In some embodiments, the remote user may provide remote assistance to the end user by establishing a remote connection to the end user computer. In particular embodiments, once the remote connection is deactivated, administrative tasks that may be running at the end user computer are terminated and processes associated with the administrative tools accessed by the remote user are shut down.

According to one embodiment, a method for using a utility at an end user device is provided. The method includes assigning an elevated access right to a remote user identifier and a limited access right to an end user identifier, where the limited access right prevents access to the utility at the end user device. The utility is accessed at the end user device using the remote user identifier, where the utility allows the remote user identifier to select an administrative tool at the end user device. The administrative tool is launched according to the elevated access right while the limited access right of the end user identifier is maintained. At least one administrative task is performed at the end user device using the administrative tool.

Various embodiments of the present invention may benefit from numerous advantages. It should be noted that one or more embodiments may benefit from some, none, or all of the advantages discussed below.

One advantage of the invention may be that security measures may be established to ensure that end users have limited access rights while allowing selected remote users to have elevated access rights. A remote user may use the elevated access rights to launch administrative tools at the end user computer while maintaining the end user logged into the network using the limited access rights.

Another advantage of an embodiment may be ease of use of a remote access system that does not require logging out of the network by the end user in order for the remote user to have elevated rights. The remote user may launch the administrative tools at the end user computer without requiring logging out by the end user. Additionally, not requiring logging out by the end user may result in less down time of the end user computer, which may increase productivity.

Yet another advantage of an embodiment may be that remote assistance may be more effective because a remote user may be able to remotely access end user restricted areas by using the remote management utility with the elevated rights assigned to the remote user. A remote connection enables the remote user to provide remote assistance to the end user, while the remote management utility elevates the access rights for the duration of the remote session. In such an embodiment, a remote user may be able to help the end user resolve computer problems from any location in the network.

Other advantages will be readily apparent to one having ordinary skill in the art from the following figures, descriptions, and claims.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a computer environment that may incorporate the use of a remote management utility in accordance with an embodiment of the present invention;

FIG. 2 illustrates an example of a computer network incorporating the remote management utility in accordance with an embodiment of the present invention;

FIG. 3 illustrates an example of a remote management utility in accordance with an embodiment of the present invention;

FIG. 4 illustrates an example of a console that may be used with a remote management utility in accordance with an embodiment of the present invention; and

FIG. 5 illustrates a method of using a remote management utility in accordance with an embodiment of the present invention.

### DETAILED DESCRIPTION OF THE DRAWINGS

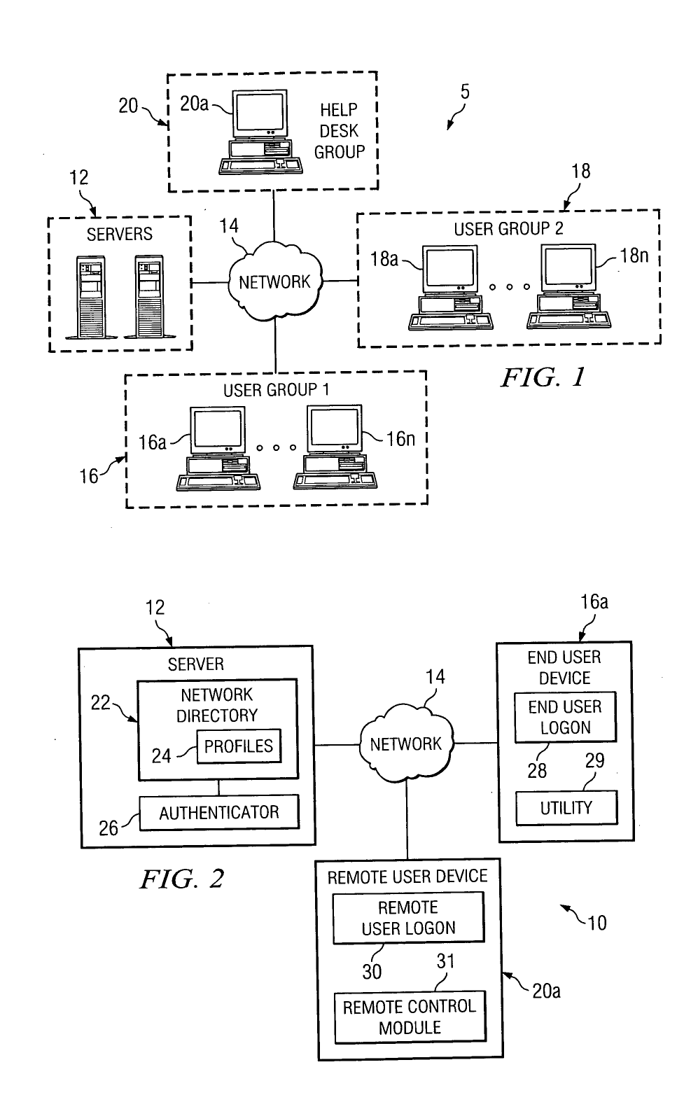

Example embodiments of the present invention and their advantages are best understood by referring now to FIGS. 1 through 5 of the drawings, in which like numerals refer to like parts.

In general, systems and methods for elevating the access right of a remote user and using a remote management utility are provided. A remote user may be assigned elevated access rights that may be used to access the utility remote management at the end user computer while maintaining limited access rights assigned to the end user. The utility launches administrative tools that may enable the remote user to perform administrative tasks at the end user computer. Additionally, the end user may be logged into the network at the end user computer, but may not be able to perform the administrative tasks at the end user computer according to the limited access rights assigned to the end user. In some embodiments, the remote user may provide remote assistance to the end user by establishing a remote connection to the end user computer. In particular embodiments, once the remote connection is deactivated, administrative tasks that may be running at the end user computer are terminated and processes associated with the administrative tools accessed by the remote user are shut down.

FIG. 1 illustrates an example of a computer environment 5 incorporating a remote management utility. Computer environment 5 may include one or more servers 12, one or more user groups 16 and 18, and one or more help desk groups 20, which may be coupled to each other by a communications network 14. Servers 12 authenticate access of all users of communication environment 5, and manage the communications between all users of communication environment 5. Help desk group 20 communicates with end users of user groups 16 and 18 using communications network 14 to provide network assistance.

According to one embodiment, user groups 16 and 18 may each include multiple end users each end user associated with an end user device. For example, user group 16 comprises end users associated with end user devices 16a, . . . 16n, while user group 18 comprises end users associated with end user devices 18a, . . . 18n. An end user may include a password, a login name, a user identifier (ID), any other suitable identifier, or all, none, or a combination of the preceding. An end user device may include a computer. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device. An end user device allows an end user to communicate with servers 12 and other end users of computer environment 5. According to one embodiment, each end user is configured with a specific access level such as a domain user, which enables the end user to log into computer environment 5 at the end user device in order to access the specific resources that a domain user in the particular user group is allowed to access. Each end users may be configured with any other suitable access level according to the security levels and network configuration desired at computer environment 5.

Servers 12 include an operating system for managing communications of computer environment 5. In one embodiment, servers 12 may be equipped with the WINDOWS NT operating system, produced by MICROSOFT. Any other operating system suitable for managing the networking functions of computer environment 5 may be used at servers 12 without departing from the scope of the invention. The operating system at servers 12 may be configured to allow end users of user group 16 to access resources common to end users of user group 16. Similarly, servers 12 may be configured to allow the end users of user group 18 to access resources common to end users of user group 18. For example, servers 12 may be configured to allow an end user associated with end user device 16a to access only those domains and printers that user group 16 is programmed to access.

Help Desk group 20 includes a group of users that may be configured to have elevated access at computer environment 5. According to one embodiment, help desk group 20 may include help desk technicians, network administrators, local administrators, network managers, or some, none, all, or a combination of the preceding. As an example only, and not by way of limitation, help desk group 20 may include help desk personnel that may need to access end user devices remotely in order to perform maintenance, troubleshoot a computer problem, improve connectivity to computer environment 5, add software or hardware at the end user device, or some, none, all, or a combination of the preceding.

Help desk group 20 includes remote users associated with remote user devices 20a. A remote user may include a password, login name, user identifier (ID), any other suitable identifier, or all, none, or a combination of the preceding. A remote user device may include a computer, or any other processing device suitable for logging into computer environment 5 and providing assistance to end users and end user devices of computer environment 5.

In one embodiment, the help desk group 20 may include one or more remote users that may be configured with different levels of access rights. For example, one remote user may be configured as a power user, while another remote user may be configured as an administrator. Each remote user may be configured with any suitable access level according to the security levels and network configuration desired at computer environment 5.

Communications network 14 facilitates communication between one or more servers 12, one or more end users, and one or more remote users. As was previously explained, communications network 14 may couple the users of computer environment 5 in order to facilitate the connectivity and communications of computer environment 5 as configured by server 12. Communications network 14 may include a local area network (LAN), a metropolitan area network (MAN), a wide area network (WAN), a global computer network such as the Internet, or any other appropriate wire line, wireless, or other links. Additionally, communications network 14 may include other suitable equipment for routing communications from several locations, backbone equipment to couple various communication sites or remote users to servers 12, and any other suitable devices.

Modifications, additions, or omissions may be made to computer environment 5 without departing from the scope of the invention. For example, computer environment 5 may be modified to include more or fewer user groups 16 and 18. As another example, user groups 16 and 18 may be omitted such as when computer network 5 includes end users that are not configured in working groups. “Each” as used in this document refers to each member of a set or each member of a subset of a set.

FIG. 2 illustrates an example of a computer network 10 incorporating the remote management utility. According to the illustrated embodiment, computer network 10 includes server 12, communications network 14, end user device 16a, and remote user device 20a coupled as shown.

Server 12 includes a network directory 22 for assigning access levels to the users of computer network 10. For example, network directory 22 may be used to setup profiles 24 for the users of computer network 10. In one embodiment, an end user of network 10 may be assigned a limited access right that may be configured at profile 24. Similarly, a remote user of computer network 10 may be assigned an elevated access right that may be configured at profile 24. Network directory 22 may include any Lightweight Directory Access Protocol (LDAP) supported directory service or any other directory service suitable for setting up access rights to computer network 10.

According to one embodiment, network directory 22 includes an ACTIVE DIRECTORY implementation. Using ACTIVE DIRECTORY, each user may be configured as an object with attributes that define the access level of the user. For example, an end user may be configured as an object in ACTIVE DIRECTORY with an attribute defining a limited access right, while a remote user may be configured as an object in ACTIVE DIRECTORY with an attribute defining an elevated access right. In one embodiment, a limited access right may include a domain user access level, while an elevated access right may include a power user access level, or any other suitable access level that allows more access than the limited access right. It will be understood that the limited access level and the remote access level may be configured in any other suitable fashion using any other suitable group definitions as it is well known in the art.

End user device 16a includes an end user logon 28 and a utility 29. In one embodiment, the end user may log into computer network 10 using an end user identifier. End user logon 28 may reside at end user device 16a if the end user logs into computer network 10 at end user device 16a. For example, an end user “John Smith” may log into computer network 10 at a computer that may store a record of “John Smith” being logged into computer network 10.

End user device 16a may communicate with server 12 to authenticate the end user and to verify the access rights associated with the end user. End user device 16a may include an operating system, such as WINDOWS XP produced by MICROSOFT, that enables end user device 16a to communicate with server 12 to verify the access right of the end user. End user device 16a may be equipped with any other suitable operating system without departing from the scope of the invention. Using the example described above, end user “John Smith” may attempt to log into computer network 10 at end user device 16a using a user name and a password that may have been previously set at profile 24. Using the user name and the password, server 12 may authenticate “John Smith” as a valid end user using authenticator 26 at server 12 and may send to end user device 16a a message authorizing “John Smith” to access the resources as determined by the access level set at profile 24. As an example and not by way of limitation, the end user, “John Smith” may gain limited access to network resources according to the attributes set at ACTIVE DIRECTORY.

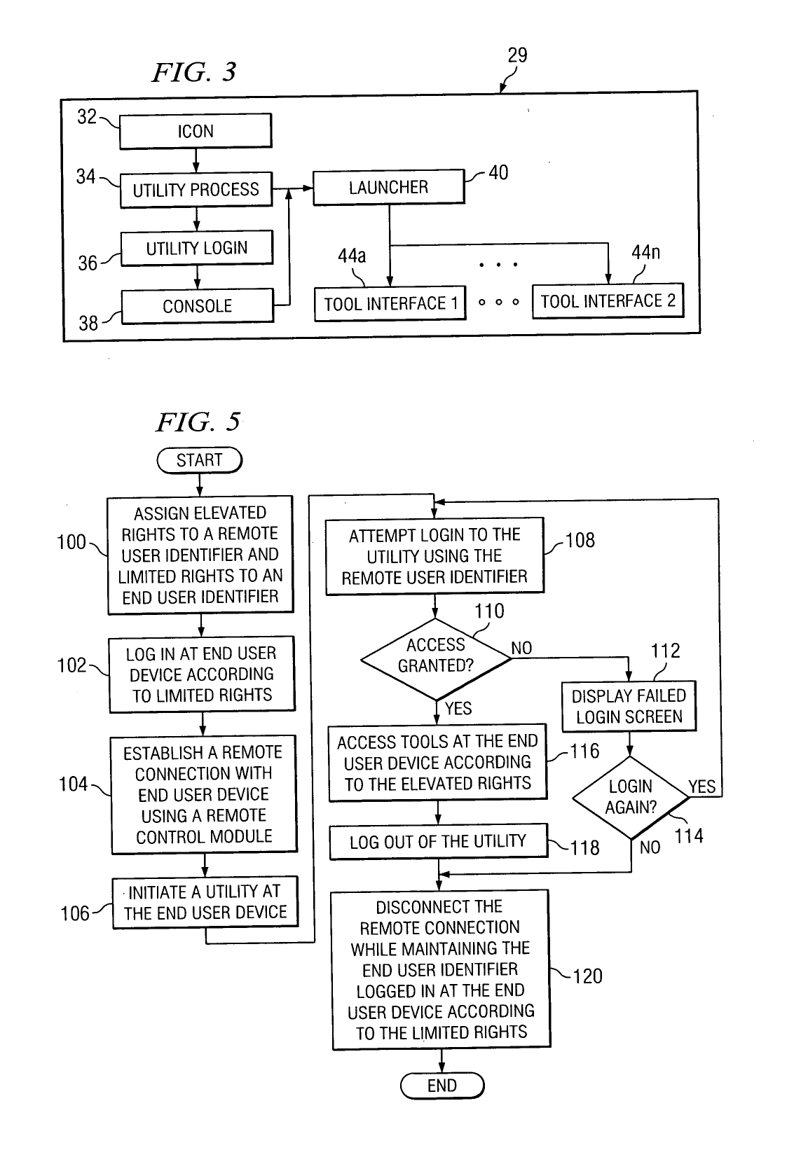

Utility 29 includes an application for launching administrative tools at end user device 16a. In one embodiment, utility 29 comprises a remote management utility capable of launching a batch application that runs WINDOWS operating system administrative tools such as the Add a Printer Wizard. In some embodiment, utility 29 includes icons representing useful applications that may be restricted to end users. For example, utility 29 may include icons representing applications for accessing network configuration setting, display settings, installation of hardware settings, installation of software settings, printer maintenance settings, and any other suitable setting that may be of interest. In another embodiment, utility 29 may provide a menu of access where an administrative tool may be launched individually without the use of a batch program. Operation of utility 29 is described in more detail with reference to FIG. 3.

Remote user device 20a includes a remote user logon 30 and a remote control module 31. In one embodiment, the remote user may log into computer network 10 using a remote user identifier. Remote user logon 30 may reside at remote user device 20a if the remote user logs into computer network 10 at remote user device 20a. For example, a remote user described as “help desk technician” may log into computer network 10 at a computer that may store a record indicating that “help desk technician” is logged into computer network 10.

Remote user device 20a may communicate with server 12 to authenticate the remote user and to verify the access rights associated with the remote user. Remote user device 20a may include an operating system, such as WINDOWS XP produced by MICROSOFT, that may enable remote user device 20a to communicate with server 12 to verify the access right of the remote user. Remote user device 20a may be equipped with any other suitable operating system without departing from the scope of the invention. Using the example described above, remote user “help desk technician” may attempt to log into computer network 10 at remote user device 20a using a user name and a password that may have been previously set at profile 24. Using the user name and password, server 12 may authenticate “help desk technician” as a valid remote user using authenticator 26 at server 12 and may send to remote user device 20a a message authorizing the “help desk technician” to access the resources as determined by the access level set at profile 24. As an example and not by way of limitation, remote user, “help desk technician” may then gain elevated access to network resources according to the attributes set at ACTIVE DIRECTORY.

Remote control module 31 may include an application that provides remote access of resources at computer network 10. In one embodiment, remote control module 31 may be used to establish a remote session from remote user device 20a to end user device 16a. Remote control module 31 may include any software program suitable for establishing a remote session between two resources at computer network 10 such as Virtual Networking Computing (VNC) produced by AT&T LABORATORIES, PCANYWHERE produced by SYMANTEC, LAPLINK produced by TRAVELLING SOFTWARE, GotoMyPC produced by EXPERTCITY, Remote Assistant, produced by MICROSOFT, or any other suitable application for remotely accessing a resource at computer network 10.

Modifications, additions, or omissions may be made to computer network 10 without departing from the scope of the invention. For example, profiles 24 may be omitted such as when ACTIVE DIRECTORY is used to set attributes to provide access levels to user. As another example, end user logon 28 and remote user logon 30 may be omitted. Server 12 may authenticate the end user and the remote user without requiring a local record of the logon at any device of network 10. It will be understood that although the term “remote user” is being used to describe a user of computer network 10 that may access end user device 16a with elevated access rights, the “remote user” may not necessarily be remote from end user device 16a.

FIG. 3 illustrates an example of a remote management utility 29. According to the illustrated embodiment, utility 29 includes icon 32, utility process 34, utility login 36, console 38, launcher 40, and tool interfaces 44a-44n. Utility 29 may include more or fewer modules and applications without departing form the scope of the invention.

Icon 32 includes a graphical interface that is associated with utility process 34. In one embodiment, icon 32 may be activated to initiate utility process 34. Icon 32 may be associated with other applications or modules of utility 29. For example, icon 32 may be associated with any “exe” file that launches one or more applications associated with utility 29.

Utility process 34 includes one or more threads that execute the remote management operations of utility 29. In one embodiment, utility process 34 includes codes, data, and resources that comprise utility 29. Utility process 34 may use at least one thread to execute the code, access the data, or establish the resources comprising utility process 34. For example, a thread of utility process 34 may run an executable file corresponding to console 38 that provides a menu of administrative tools that may be launched at utility 29.

Utility process 34 may initiate utility login 36 to verify access to utility 29. In one embodiment utility login 36 comprises a domain login that utility process 34 may use to authenticate the user login in. For example, utility login 36 displays a login screen requesting a user name and password that utility login 36 forwards to authenticator 26 of server 12 to verify if the user has elevated rights. In one embodiment, utility login 36 requests a logic answer of “True” or “False” corresponding to the authentication value of the user login as compared to the attribute entry in ACTIVE DIRECTORY. If the user login is authorized, utility login 36 receives a logical answer of “True” and, grants access to console 38. If the user login is not authorized, such as by receiving a logical answer of “False” from server 12, utility login 36 does not grant access to console 38 and may provide the user a subsequent attempt to login. Utility login 36 may request any other suitable information to grant access to utility 29 and may provide any suitable number of login attempts to a user.

In one embodiment, utility login 36 initiates a process that elevates access rights at end user device 16a. For example, if the remote user has access to utility 29, a “runas” process may launch other processes at the elevated access right of the remote user. For example, the “runas” process may initiate any process associated with utility 29 such as a console process, using an elevated access right, for example, an administrator level access right.

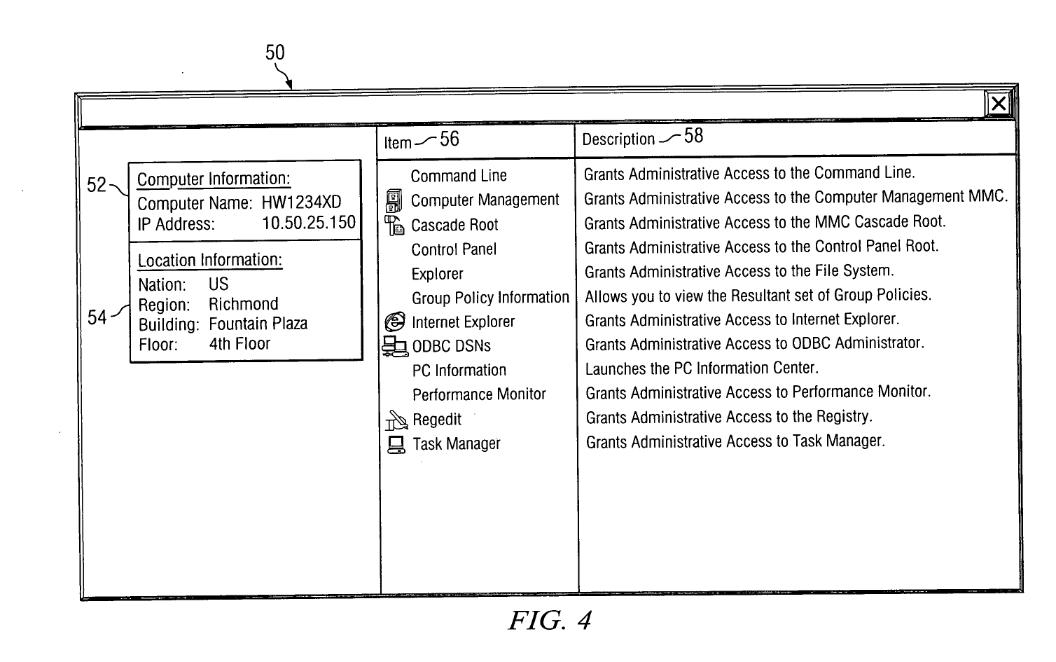

Console 38 provides a menu layer that interfaces with launcher 40 and tool interfaces 44a-44n. In one embodiment, console 38 includes a thread that provides a menu of the administrative tools that may be accessed with utility 29. Referencing now FIG. 4, console 38 may provide a list of administrative tools that may be launched with utility 29. For example, console 38 may list a “Control Panel” item that launches the WINDOWS Control Panel using the elevated access rights. Console 38 may include icons, a detailed list of applications, a batch program selection, thumbnails, or any other interface suitable for accessing the administrative tools that may be accessed with utility 29.

FIG. 4 illustrates an example of a console 38 that may be used with the remote management utility. Console 38 includes items 56, description 58, computer information 52, and location information 54 as shown. Although a list of items 56 and descriptions 58 are described, console 38 may provide menu items in form of icons, application details, thumbnails, or any other suitable representation of administrative tools that may be accessed through utility 29. Additionally, although a list of items 56 has been provided, any other suitable administrative tool may be included in items 56 with a corresponding description 58 without departing from the scope of the invention.

In one embodiment, items 56 list the administrative tools that the remote user may launch in order to perform administrative tasks at end user device 16a. For example, the remote user may access the “Control Panel” in order to change printers at end user device 16a. Description 58 may include a corresponding description of the type of item 56 that is available. For example, the description 58 corresponding to the item 56 “Control Panel” describes that item as granting “Administrative Access to the Control Panel”. Description 58 may provide additional information without departing from the scope of the invention. In other embodiments, description 58 may be omitted.

Computer information 52 may be included at console 38 to provide information corresponding to end user device 16a. In the illustrated embodiment, computer information 52 includes a computer name and an Internet Protocol (IP) address corresponding to end user device 16a. The remote user may use computer information 52 to identify end user device 16a in computer network 10. Computer information 52 may include more or less information without departing from the scope of the invention. For example, computer information 52 may include information corresponding to the operating system running at end user device 16a.

Location information 54 may be included at console 38 to provide information corresponding to the location of end user device 16a. In the illustrated embodiment, location information 53 includes information on the nation, region, building, and floor where end user device 16a may be located. This information may be useful to identify the physical location of end user device 16a. Location information 54 may include more or less information without departing from the scope of the invention. For example, in a simple enterprise, location information 54 may include information regarding only the floor where end user device 16a is located.

Modifications, additions, or omissions may be made to console 38 without departing from the scope of the invention. For example, console 38 may include information regarding the remote connection detected at end user device 16a. As another example, computer information 52 and location information 54 may be omitted. As yet another example, more or fewer administrative tools may be listed at item 56 without departing from the scope of the invention.

Referring back to FIG. 3, console 38 detects if there is a remote connection at end user device 16a. In one embodiment, the remote user may log into end user device 16a through a remote connection. Console 38 may detect if the user is remote or local so that console 38 may monitor the remote connection, if any. Console 38 may disconnect all threads and processes running at end user device 16a upon detecting a break in the remote connection. By disconnecting all threads and processes, console 38 provides security control of access to administrative tools. For example, console 38 may cease access to the “Control Panel” at end user device 16a upon detecting a break in a remote connection between the remote user device and end user device. If the remote user logs into end user device 16a locally, console 38 does not monitor remote connection. Console 38 may monitor any suitable remote connection at end user device 16a without departing from the scope of the invention.

Launcher 40 launches the administrative tools that may be accessed by console 38. In one embodiment, launcher 40 includes a sub-thread of console 38 that executes the administrative tools using tool interfaces 44a-44n. For example, console 38 may list the administrative tool “Control Panel” that launcher 40 may launch upon being activated, such as by double-clicking on the tool interface for the “Control Panel”. Tool interfaces 44a-44n may include icons, list of applications, thumbnails, or any other suitable representation of an administrative tool available at console 38. As an example only, and not by way of limitation, tool interfaces 44a-44n may include an item list such as items 56 as described with reference in FIG. 4. Additionally, tool interfaces 44a-44n may be activated using any other suitable function, for example, by pressing the key “ENTER” on a keyboard while a screen pointer is located proximate to the tool interface 44n.

Modifications, additions, or omissions may be made to utility 29 without departing from the scope of the invention. For example, utility 29 may include more or fewer modules. As another example, launcher 40 may be included at console 38 so that console 38 launch the administrative tools. As yet another example, utility 29 may include a security module that interfaces with utility login 36 to ensure that proper authorization is obtained from server 12 and that the administrative tools accessed through console 38 are accessed at the appropriate access level right.

FIG. 5 illustrates a method of using the remote management utility. The method begins at step 100, where elevated access rights are assigned to a remote user identifier and limited access rights are assigned to an end user identifier. As was described with reference to FIG. 2, the remote user identifier is assigned elevated access rights at network directory 22 using profile 24 or any other LDAP based technique. Similarly, the end user identifier is assigned limited access rights at network directory 22 using profile 24 or any other LDAP based technique.

At step 102, the end user logs into end user computer 16a using the end user identifier according to the limited access rights. As was described with reference to an example, the end user may use an end user name and a password to log into end user device 16a. End user device 16a is coupled to server 12 via communications network 14 so that authenticator 26 may verify that the end user has the appropriate access rights to log into computer network 10. Once logged in, the end user may operate end user device 16a according to the assigned limited access rights.

The remote user establishes a remote connection with end user device 16a using remote control module 31, at step 104. For example, if the remote user is remotely located from end user device 16a, the remote user may access remote control module 31 at remote user device 20a to establish a remote connection with end user device 16a. As was described with reference to FIG. 2, the remote connection may be used to remotely control the local environment of end user device 16a. In another embodiment, the remote user may be proximate to end user device 16a so that a remote connection may not be necessary. For example, the remote user may log into end user device 16a directly as has already been described.

At step 106, the remote user initiates utility 29 at end user device 16a. According to one embodiment, the remote user, either locally or remotely, accesses the desktop of end user device 16a in order to have access to the applications local to end user device 16a. For example, the remote user may access utility 29 installed locally at end user device 16a by double-clicking icon 32 corresponding to utility 29. The remote user may initiate utility 29 using any other suitable function, such as by locating and activating utility 29 at the Programs menu of a WINDOWS desktop environment.

Once utility 29 has been initiated, a login screen may prompt the remote user to enter the corresponding remote user identifier. At step 108, the remote user attempts to log into utility 29 using the remote user identifier. As was described with reference to one example of FIG. 2, the remote user may use a user name and a password to log into utility 29.

Utility 29 receives the remote user identifier and determines if access to administrative tools is granted at step 110. In one embodiment, utility 29 receives the user name and password from the remote user and verifies if the remote user is in the appropriate profile group. For example, the remote user may be a help desk technician that is set up as a member of a group having elevated access rights such as administrator rights. As another example, an LDAP type group may be set up at network directory 22 to define the remote users that may have access to utility 29.

If access is not granted at step 110, the method proceeds to step 112, where utility 29 displays a failed login screen. According to one embodiment, utility 29 may provide additional opportunities for a user to attempt a successful login. For example, at step 114, utility 29 may provide the option to login again. According to another embodiment, if access is not granted at step 110, utility 29 may exit without providing additional login attempts. For example, at step 114, utility 29 may not provide the option to login again, and the method may disconnect the remote connection established at step 104 and terminate. Additionally, utility 29 may cause a security exception entry at a security log to track the failed login attempt.

If access is granted at step 110, the method proceeds to step 116, where console 38 provides access to the administrative tools according to the elevated access rights. According to one embodiment, utility 29 runs a thread that executes console 38, which provides access to the administrative tools of utility 29 using, for example, administrative rights to end user device 16a. Console 38 allows the remote user to perform administrative tasks associated with the administrative tools available at utility 29. In one embodiment, the remote user may perform the administrative tasks without requiring that the end user logs out of computer network 10 at end user device 16a.

At step 118, the remote user logs out of utility 29. In one embodiment, the remote user may exit utility 29 by closing the window for utility 29. In another embodiment, utility 29 may exit automatically after detecting that a break in the remote connection has been detected. Logging out of utility 29, or any other function that causes utility 29 to shut down, causes a shut down of all threads started with elevated access rights. For example, if the remote user runs the “Control Panel” to add a printer, and the remote user logs out or exits utility 29, the threads started to perform the printer addition at the “Control Panel” are shut down. Additionally, a rights token may be revoked for the main thread.

After logging out or exiting utility 29, the remote connection is disconnected at step 120. The end user may continue to be logged into computer network 10 at end user device 16a during the remote connection, and after the remote connection has been discontinued. This may facilitate remote assistance to an end user because the end user is not required to log out of the network in order for a remote user to be able to access administrative tools at end user device 16a. After discontinuing the remote connection, the method terminates.

Modifications, additions, or omissions may be made to the method without departing from the scope of the invention. Additionally, steps may be performed in any suitable order without departing from the scope of the invention. For example, establishing a remote connection with an end user device using remote control module 31 at step 104 may be omitted if the remote user accesses utility 29 locally at end user device. As another example, displaying a failed login screen at step 112 may be omitted such as when utility 29 exits the program automatically after a first failed attempt. As yet another example, logout of utility at step 118 may be omitted such as when utility 29 detects a break in the remote connection. As yet another example, a step may be added where utility 29 determines if there is a remote connection in place between remote user device 20a and end user device 16a.

Although an embodiment of the invention and its advantages are described in detail, a person skilled in the art could make various alterations, additions, and omissions without departing from the spirit and scope of the present invention as defined by the appended claims.

1. A method for using a utility at an end user device, comprising:
assigning an elevated access right to a remote user identifier and a limited access right to an end user identifier, the limited access right operable to prevent access to the utility at the end user device;
accessing the utility at the end user device using the remote user identifier, the utility operable to allow the remote user identifier to select an administrative tool at the end user device;
launching the administrative tool according to the elevated access right while maintaining the limited access right of the end user identifier; and
performing at least one administrative task at the end user device using the administrative tool.

2. The method of claim 1, wherein assigning an elevated access right to a remote user identifier and a limited access right to an end user identifier further comprises:
setting up at a network directory a remote user profile for the remote user identifier, the remote user profile associating the remote user identifier with the elevated access right; and
setting up at the network directory an end user profile, the end user profile associating the end user identifier with the limited access right.

3. The method of claim 1, wherein accessing the utility at the end user device using the remote user identifier further comprises
receiving the remote user identifier;
authenticating the remote user identifier using a network directory, the network directory comprising a profile associating the remote user identifier with the elevated access right; and
granting access to the utility using the elevated access right.

4. The method of claim 1, further comprising establishing a remote connection using a remote control module at a remote user device.

5. The method of claim 4, further comprising:
detecting a break in the remote connection; and
closing at least one process, the at least one process corresponding to the administrative tool used to perform the administrative task.

6. The method of claim 1, wherein the remote user identifier is associated with the remote user device, the remote user device located at a separate location from the end user device.

7. The method of claim 1, wherein the administrative task comprises operations that affect the settings of the end user device.

8. The method of claim 1, wherein the end user device comprises an operating system selected from a group consisting of WINDOWS XP and WINDOWS 2000.

9. A method of elevating an access right at an end user device, comprising:
receiving an authentication message from a network in response to a login request from a remote user identifier, the authentication message operable to inform if the remote user identifier is associated with an elevated access right, the elevated access right operable to allow access to an administrative tool at the end user device;
generating an elevated access layer using the elevated access right, the elevated access layer operable to:
initiate an administrative tool at the end user device; and
elevate the access right of the remote user identifier according to the elevated access right;
launching the administrative tool using the elevated access layer; and
processing at least one administrative task at the end user device using the administrative tool while maintaining an end user identifier logged into the network with a limited access right, the limited access right operable to prevent access to the administrative tool at the end user device.

10. The method of claim 9, further comprising detecting a remote connection from the remote user device, the remote connection operable to access the end user device using a remote control module at the remote user device.

11. The method of claim 10, further comprising discontinuing at least one process associated with the administrative tool upon detecting a break in the remote connection.

12. The method of claim 9, wherein the remote user identifier is associated with a remote user device, the remote user device being at a separate location from the end user device.

13. A system for elevating access rights of a remote user, comprising:
a network directory operable to assign an elevated access right to a remote user identifier and a limited access right to an end user identifier;
a utility stored at an end user device and operable to:
launch the administrative tool according to the elevated access right while maintaining the limited access right of the end user identifier, the limited access right operable to prevent access to the utility at an end user device; and
perform at least one administrative task at the end user device using the administrative tool; and
a remote user device operable to access the utility at the end user device using the remote user identifier in order to perform the at least one administrative task at the end user device.

14. The system of claim 13, the network directory further operable to:
set up a remote user profile for the remote user identifier, the remote user profile associating the remote user identifier with the elevated access right; and
set up an end user profile, the end user profile associating the end user identifier with the limited access right.

15. The system of claim 13, the utility further operable to:
receive the remote user identifier;
authenticate the remote user identifier using a network directory, the network directory comprising a profile associating the remote user identifier with the elevated access right; and
granting access to the administrative tool using the elevated access right.

16. The system of claim 13, the remote user device further operable to establish a remote connection using a remote control module.

17. The system of claim 16, the utility further operable to:
detect a break in the remote connection; and
close at least one process, the at least one process corresponding to the administrative tool used to perform the administrative task.

18. The system of claim 13, wherein the remote user identifier is associated with the remote user device, the remote user device located at a separate location from the end user device.

19. The system of claim 13, wherein the administrative task comprises operations that affect the settings of the end user device.

20. The system of claim 13, wherein the end user device comprises an operating system selected from a group consisting of WINDOWS XP and WINDOWS 2000.

21. Software for elevating an access right at an end user device, the software embodied in a computer medium and operable to:
receive an authentication message from a network in response to a login request from a remote user identifier, the authentication message operable to inform if the remote user identifier is associated with an elevated access right, the elevated access right operable to allow access to an administrative tool at the end user device;
generate an elevated access layer using the elevated access right, the elevated access layer operable to:
initiate an administrative tool at the end user device; and
elevate the access right of the remote user identifier according to the elevated access right;
launch the administrative tool using the elevated access layer; and
process at least one administrative task at the end user device using the administrative tool while maintaining an end user identifier logged into the network with a limited access right, the limited access right operable to prevent access to the administrative tool at the end user device.

22. The software of claim 21, further operable to detect a remote connection from the remote user device, the remote connection operable to access the end user device using a remote control module at the remote user device.

23. The software of claim 21, further operable to discontinue at least one process associated with the administrative tool upon detecting a break in the remote connection.

24. The software of claim 21, wherein the remote user identifier is associated with a remote user device, the remote user device being at a separate location from the end user device.

25. A system for using a utility at an end user device, comprising:
means for assigning an elevated access right to a remote user identifier and a limited access right to an end user identifier, the limited access right operable to prevent access to the utility at the end user device;
means for accessing the utility at the end user device using the remote user identifier, the utility operable to allow the remote user identifier to select an administrative tool at the end user device;
means for launching the administrative tool according to the elevated access right while maintaining the limited access right of the end user identifier; and
means for performing at least one administrative task at the end user device using the administrative tool.

26. A system for elevating an access right at an end user device, comprising:
means for receiving an authentication message from a network in response to a login request from a remote user identifier, the authentication message operable to inform if the remote user identifier is associated with an elevated access right, the elevated access right operable to allow access to an administrative tool at the end user device;
means for generating an elevated access layer using the elevated access right, the elevated access layer operable to:
initiate an administrative tool at the end user device; and
elevate the access right of the remote user identifier according to the elevated access right;
means for launching the administrative tool using the elevated access layer; and
means for processing at least one administrative task at the end user device using the administrative tool while maintaining an end user identifier logged into the network with a limited access right, the limited access right operable to prevent access to the administrative tool at the end user device.

27. A method of elevating an access right at an end user device, comprising:
receiving an authentication message from a network in response to a login request from a remote user identifier, the authentication message operable to inform if the remote user identifier is associated with an elevated access right, the elevated access right operable to allow access to an administrative tool at the end user device, the remote user identifier associated with a remote user device, the remote user device being at a separate location from the end user device;
generating an elevated access layer using the elevated access right, the elevated access layer operable to:
initiate an administrative tool at the end user device; and
elevate the access right of the remote user identifier according to the elevated access right;
launching the administrative tool using the elevated access layer; and
processing at least one administrative task at the end user device using the administrative tool while maintaining an end user identifier logged into the network with a limited access right, the limited access right operable to prevent access to the administrative tool at the end user device;
detecting a remote connection from the remote user device, the remote connection operable to access the end user device using a remote control module at the remote user device; and
discontinuing at least one process associated with the administrative tool upon detecting a break in the remote connection.
